(19) United States
(12) Patent Application Publication
(10) Pub. No.: US 2017/0091888 A1
(43) Pub. Date: Mar. 30, 2017

(54) USER-TRIGGERED REACTIVE EMERGENCY ACCOUNT PROTECTION

(71) Applicant: Google Inc., Mountain View, CA (US)

(72) Inventors: Dan FREDINBURG, San Francisco, CA (US); Andreas Michael TUERK, Woerthsee (DE); Martin ORTLIEB, Zurich (CH); Elin Roenby PEDERSEN, Portola Valley, CA (US); Lisa PETERSON, Cupertino, CA (US); Heather Lynn TRAHER, San Francisco, CA (US); Sebastian Schnorf WILDERMUTH, Zurich (CH); Kalle KORMANN-PHILIPSON, Munich (DE); Sara Elisabeth ADAMS, Munich (DE); Jessica STADDON, Mountain View, CA (US)

(73) Assignee: Google Inc., Mountain View, CA (US)

(21) Appl. No.: 14/133,368

(22) Filed: Dec. 18, 2013

Related U.S. Application Data
(60) Provisional application No. 61/798,275, filed on Mar. 15, 2013.

(51) Int. Cl. G06Q 50/26; G06Q 10/10

(52) U.S. Cl. CPC G06Q 50/265; G06Q 10/10

(57) ABSTRACT

Examples of user-triggered reactive emergency account protection are provided, including receiving a request from a first user to suspend online-account activity, wherein the online-account activity includes providing at least one other user with access to information associated with the first user; in response to the request, suspending the online-account activity so that the at least one other user cannot access the information associated with the first user; and providing online interactive guidance to the first user, so as to assist the first user to resume at least a portion of the online-account activity.

### BACKGROUND

1. Technical Field

The subject matter discussed herein relates generally to online services and, more particularly, to user-triggered reactive emergency account protection.

2. Related Background

A typical person may have at least one online account. Commonly, people have online accounts that are associated with electronic communication (e.g., email), photo sharing services, video sharing websites, social networks, etc.

A user of the online account communicates with other users. The user may communicate directly with another user (e.g., sending and receiving emails or text messages). The user may communicate indirectly with another user through, for example, an online social network (e.g., posting content on an online social network that is not designated for any specific user, but for a plurality of users having a common trait or characteristic).

At one point or another, communicating online may pose problems that need to be resolved, such as accidentally activating a software virus, falling victim to a phishing scam, or otherwise experiencing a privacy and/or security incident. For example, users may find themselves in a situation where it is necessary to immediately address an online issue. For example, but not by way of limitation, a user may have discovered that he or she is still sharing a calendar with another user with whom he or she no longer has a close relationship; or that one of the user's photos is suddenly attracting a lot of attention from users that he or she does not know, such that their online account appears to have been “hijacked.” As a result, a user may be frightened or confused as to how to respond in these situations.

As a result, a user due to his or her last name, may be targeted by unknown users, (e.g., strangers), and may receive one or more undesired comments on his or her online profile picture. Without further guidance on how to address this issue, the user may abandon his or her online account.

### SUMMARY

Examples of user-triggered reactive emergency account protection are described. One example is a mechanism (e.g., single-action or one-click) that allows a user to react quickly to a situation (e.g., an emergency situation) where the user can suspend or “freeze” all activity associated with one or more of the user's accounts.

The subject matter includes at least a computer device, a computer product, and a method for receiving a request from a first user to suspend online-account activity, wherein the online-account activity includes providing at least one other user with access to information associated with the first user; in response to the request, suspending the online-account activity so that the at least one other user cannot access the information associated with the first user; and providing online interactive guidance to the first user, so as to assist the first user to resume at least a portion of the online-account activity.

According to an example implementation, a computer-implemented method is provided for user-initiated suspension of online-account activity associated with a first user, and assisting the first user to revoke the user-initiated suspension of the online-account activity, the method comprising receiving a request from the first user to suspend the online-account activity, wherein the online-account activity comprises providing at least one other user with access to information associated with the first user; in response to the request, suspending the online-account activity so that the at least one other user cannot access the information associated with the first user; and providing online interactive guidance to the first user, so as to assist the first user to resume at least a portion of the online-account activity.

According to another example implementation, a non-transitory computer readable medium is provided, having stored therein computer executable instructions for user-initiated suspension of online-account activity associated with a first user, and assisting the first user to revoke the user-initiated suspension of the online-account activity, the instructions comprising receiving a request from the first user to suspend the online-account activity, wherein the online-account activity comprises providing at least one other user with access to information associated with the first user; in response to the request, suspending the online-account activity so that the at least one other user cannot access the information associated with the first user; and providing online interactive guidance to the first user, so as to assist the first user to resume at least a portion of the online-account activity.

According to yet another example implementation, at least one device is provided, comprising a storage and at least one processor configured for user-initiated suspension of online-account activity associated with a first user, and assisting the first user to revoke the user-initiated suspension of the online-account activity, the at least one processor receiving a request from the first user to suspend the online-account activity, wherein the online-account activity comprises providing at least one other user with access to information associated with the first user; in response to the request, suspending the online-account activity so that the at least one other user cannot access the information associated with the first user; and providing online interactive guidance to the first user, so as to assist the first user to resume at least a portion of the online-account activity.

### BRIEF DESCRIPTION OF THE DRAWINGS

FIG. 1 shows an example login user interface according to at least one example implementation.

FIG. 2 shows an example environment where account protection can be initiated and implemented according to some example implementations.

FIG. 3 shows an example process suitable for implementing some example implementations.

FIG. 4 shows an example computing environment with an example computing device suitable for implementing at least one example implementation.

### DETAILED DESCRIPTION

The subject matter described herein is taught by way of example implementations. Various details have been omitted for the sake of clarity and to avoid obscuring the subject matter. Examples shown below are directed to structures and functions for implementing user-triggered reactive emergency account protection.

### Definitions

As used herein, the term “online account” or “account” refers to a product, service, or application associated with a user (e.g., user JJ335). A user may have, subscribe to, and/or use one or more accounts or online accounts (e.g., user JJ335 may have an email account, a social network account, a photo sharing account, a video sharing account, an online storage account, a mobile account, a blog account, etc.). Each of the email service, social network, photo sharing service, video sharing service, online storage, and/or mobile service, etc. can be referred to as a product, service, or application.

Other products may include, but are not limited to, maps, generalized user query (e.g., general search), focused search (e.g., searching people, patent, scholar, etc.), shopping cart, checkout, news, translation, toolbar, calendar, instant messaging, short message service, voice, phone, and/or toll-free service, etc.

An account can be an internet or external account (e.g., an end user subscribing to an openly, publicly, or semi-publicly available service), an intranet or internal account (e.g., an employee subscribing to a service of a company or firm), an extranet or controlled availability account (e.g., an account available to vendors, customers, or other controlled subscribers), or another type of account.

### Overview

According to example implementations, three different approaches are provided. One example approach involves an “emergency card” that assists a user to take appropriate action. Another example approach includes a “wizard” that guides the user through a possible issue and/or solution. Yet another example approach involves a “freeze,” which locks-down the user's account, so that he or she can address the issues associated with the online emergency.

A mechanism (e.g., single-action or one-click) that allows a user to react quickly to a situation (e.g., an emergency situation) where the user can suspend or “freeze” all activity associated with one or more of the user's accounts. The mechanism may be implemented to automatically alert service providers of the user's accounts that the user believes that he or she is experiencing a problem with his or her accounts (e.g., having security and/or privacy issues). The user may be provided assistance to identify the problem and take one or more steps to recover, gradually or quickly, account functionality and/or activities that lead to resuming or “unfreezing” the account. The assistance may come in any form, including the form of a wizard, interview, emergency card (e.g., check list), or a combination thereof.

Example implementations are directed to assisting a user once an online situation or emergency has occurred. For example, but not by way of limitation, triggers for determining the existence of an online situation or emergency may include the following:
a. Reaction to stalker. In this situation, a user may identify his or her properties, such as a profile, a blog, or the like. When these properties have been accessed by the same user or IP address more than a prescribed number of times, or a threshold has been exceeded, a panic alert is triggered. As a result, a panic alert is triggered, such as a notification that is provided to the user which indicates to the user that he or she may be being stalked. For example, the phrase, “looks like you're being stalked” may appear as a notification.
b. Hijacking. In this situation, the example implementations or a user register can confirm that an account of a user has been hijacked. However, the user still has access to the hijacked account. Therefore, a panic alert is triggered, and sent out to the user whose account has been hijacked over a secure secondary channel. Because the hijacker would see a notification that is sent to the account into which the hijacker has been logged in, a notification is not sent to the account on which the user is logged in.
c. Strange/odd activities. The online system of the example implementations may register a strange or odd activity within the account. For example, but not by way of limitation, the system may register that the account has been signed into from various geographical locations or IP addresses at the substantially same time, or in very short time intervals. Alternatively, the system may register that the wrong password has been entered more than a certain number of times, such as 5 times in a row. Additionally, symptoms of abuse, such as a massive increase in a number of sent email messages, a complete deletion of an address book, or a sudden deletion of all messages in an inbox, while an email forward message is being sent, may indicate a strange or odd activity. Further, if the system notices that a substantial amount of email activity from the account of the user has been flagged as spam, or that images on an image viewing tool of the user's account are getting lots of views suddenly, the system may register that a strange or odd activity has occurred. Accordingly, in this situation the example implementation triggers a panic alert, such that a user is notified over a secure, secondary channel, and a notification is shown to the user of the online account indicating that something unusual is occurring in the account.
d. Changing social circumstance. In this example implementation, an individual who was once a trusted person for the online user is no longer a trusted person for the online user. For example, this may involve termination of a personal or professional relationship. Later, the online user realizes that the formerly trusted person still has access to data of the online user. As a result, access rights must be revoked for this formerly trusted person. As a result, a user may select a static object such as a “panic button.” As a result, a panic action is invoked.
e. Data leakage. A user or the system may register a leakage of data. For example, this may include personal data of the user that should not be publicly viewable, but is publicly viewable nonetheless. As a result, a panic alert is triggered, indicating to the online user that some of his or her data may be leaking.
f. Mis-sharing events. In this example implementation, a user has posted content or shared a document or image with other online users. Later, the user realizes that the list of recipients contains unintended recipients, or too many recipients. Alternatively, a user may have shared content with other users who are not supposed to receive the content, or the content has been made publicly available on the internet, which greatly increases access to the content. As a result, the example implementation triggers a panic alert, and a user is provided with an indication that data is being given a disproportionate amount of attention.

According to an example implementation employing a wizard approach, an online user may be guided through a number of potential issues that he or she may be experiencing. The user is then provided suggested user actions and/or proposed action(s) to be taken by the system on behalf of the user. In some example implementations, if the system has a capability that provides information as to the cause of the user's issue, certain steps of the wizard can be bypassed, such that the wizard jumps directly to specific steps and/or actions. On the other hand, if it is unclear as to the user's issue, the full wizard may be employed, with all of the steps. Alternatively, the wizard may be employed without considering any known or predicted causes, such that the user is walked through all of the steps of the wizard in each and every instance.

The wizard may be invoked by an object on an interface, such as a button or link. The object may be static, such that the user can easily reach and trigger the wizard. Alternatively, the object may be dynamic, such that the wizard is triggered in the notification of the potential privacy incident, or through a secure secondary channel.

Additionally, the wizard may run automatically (e.g., regularly in the background), or in response to one of the triggers. An analytical tool may be employed to establish baseline behavior patterns, identify divergent behavior so that information can be generated, and notify a user of the divergent behavior. The notification system includes a secure secondary channel, such as a mobile channel. The secure secondary channel is used to send alerts when personal analytics have detected divergent behavior. Additionally, on-screen notification may be provided when a user is signed-in to an account in certain circumstances. For example, a user may be alerted when personal analytics have detected divergent behavior, and the notification may invoke the wizard.

Once the wizard has been invoked, either through the static object as explained above, through the dynamic object as explained above, or automatically based on information identified by the system, the user is led through the wizard. More specifically, the user is posed a stack of questions and proposed user actions, which have been prioritized based on the information received from the above-explained personal analytics. For example, but not by way of limitation, a decision tree may be employed. The wizard can transmit commands to other parts of the system, which must execute these commands. For example, an image sharing tool may be required to turn off all sharing of information.

According to an “emergency card” approach according to the example implementations, a user may be guided to a centralize help site, which describes possible issues and steps a user may take. Based the information on the page, a user may choose an appropriate path of action. The emergency card may be invoked from a static object or a dynamic object, as described above with respect to the wizard implementation. Once the emergency card has been invoked, a static help center may be provided which contains links to instructions for user actions for various issues. Alternatively, a contextual help center approach may be employed. According to this approach, depending on the personal analytics identified issue, links may be provided contextually to information on the help center, with further information on how a user may address this emergency issue.

According to the freeze approach of the example implementations, a user may be taken offline immediately. For example, sharing of objects may be terminated, all profile information for user sharing may be set to “only you,” and all activities and information associated with the user may be made “invisible” to other users or to being publicly available online on the internet. In this scenario, the system goes into “lockdown” mode.

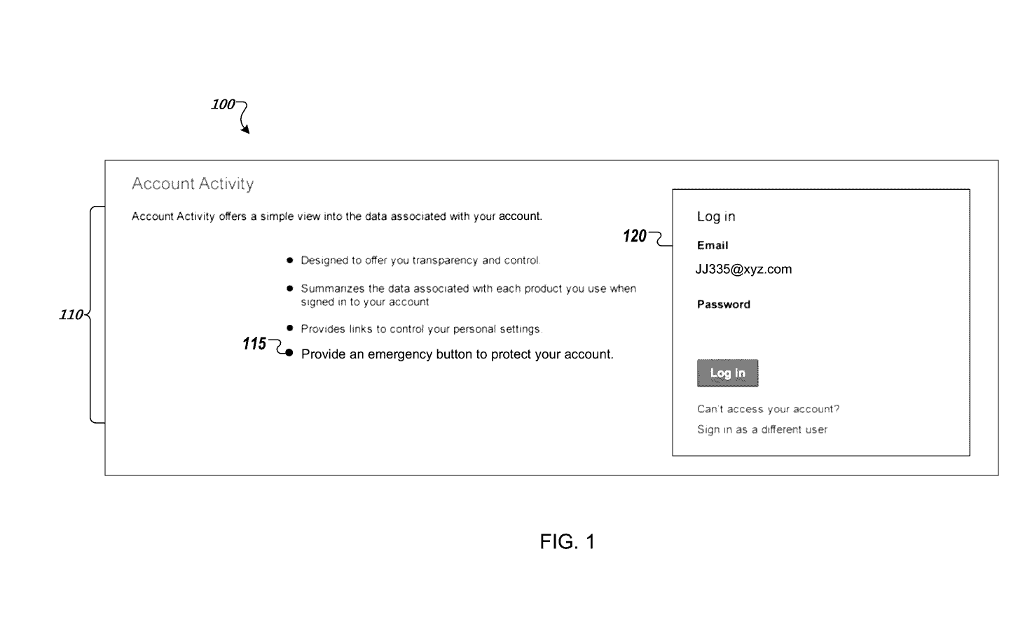

FIG. 1 shows an example login user interface according to at least one example implementation. User interface (UI) 100 includes information 110, which informs a user of various available features, which may include a lockdown option 115. A user (e.g., user JJ335) may login through widget 120. For example, a text field or fields may prompt the user to enter a user name and password. Information 110 indicates that user JJ335 may view, after logging in to the account, summaries of data associated with each product used, control personal settings, and/or lockdown the user's data.

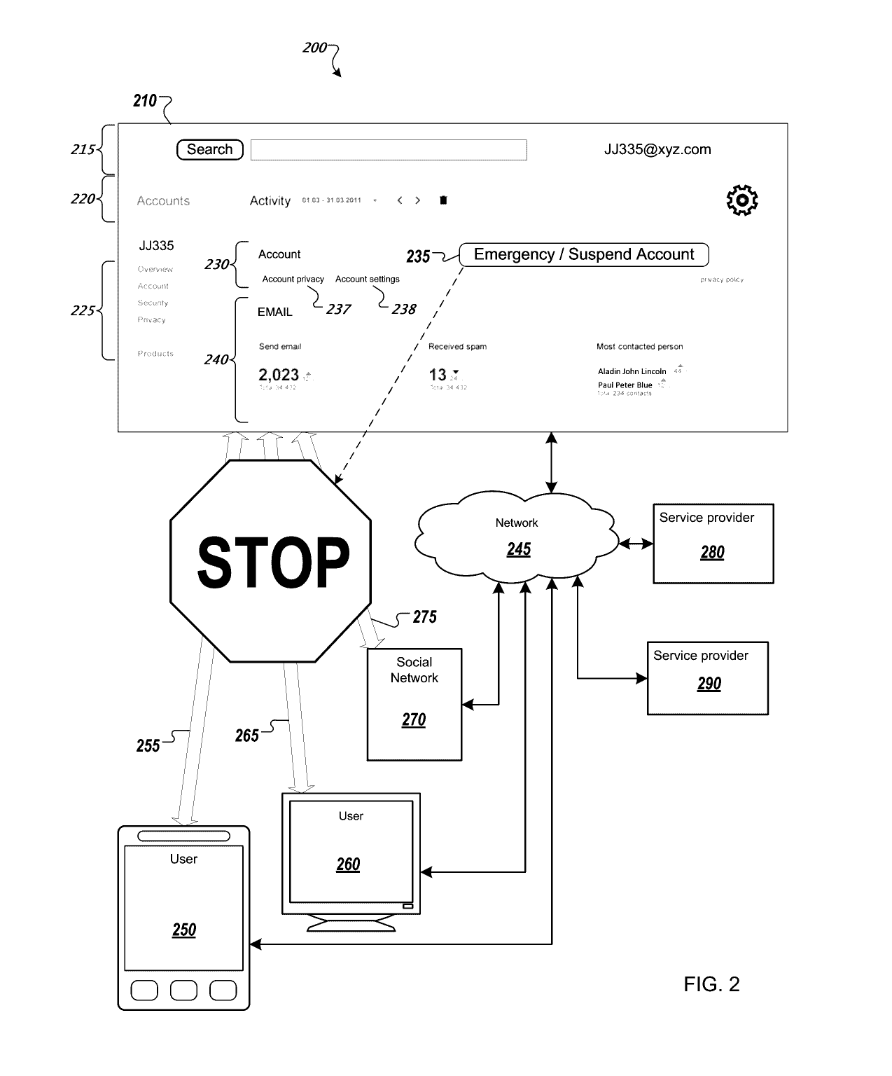

FIG. 2 shows an example environment where account protection can be initiated and implemented according to some example implementations. Environment 200 includes user interface (UI) 210, which is presented on a device (not shown) communicatively connected to a service provider (e.g., servicer provider 280 or 290), user 250, user 260, and social network 270 through, for example, network 245. User 250 and user 260 may access social network 270 and/or access services provided by servicer provider 280 and/or 290. Social network 270, servicer provider 280, and/or servicer provider 290 may be operated commonly or independently by separately controlled entities.

UI 210 includes, in region 215, an icon, search input box and other information and/or widgets. Region 220 may show information such as a page title (e.g., “Accounts”) and information about the “Accounts” (e.g., “Activity” statement or report for the period of March 2011). Below region 220 may be a region (e.g., column) of navigation options 225. In region 230, on the right of navigation options 225, may be a content heading (e.g., “Account”), a button 235 (e.g., “Emergency/Suspend Account” button), and other controls (e.g., account privacy 237 and account settings 238). Below region 230 may be one or more regions of content, such as region 240. JJ335's “Email” account in region 240 shows his or her email activity for the month of March 2011 (e.g., “Mar. 1-31, 2011”).

In some example implementations, JJ335 may subscribe to (e.g., service provider 280 and/or 290) and use other online services or products. For example, JJ335 may have a photo sharing account, a video sharing account, a social network account (e.g., with social network 270), mobile service account, and other accounts. Activity and/or usage associated with these accounts may be summarized, reported, and/or provided in UI 210, for example, as additional regions (not shown) below region 240.

The layout, information, widgets, and content shown in UI 210 are for illustration purposes only. In implementation, any of the layout, information, widgets, and content may be different. For example, the spatial arrangement and orientation of the various regions may be modified, as would be understood by one skilled in the art.

Regardless of how many accounts JJ335 may have, a mechanism, such as “Emergency/Suspend Account” object or button 235 or another widget that provides JJ335 the ability to quickly suspend activity associated with all of JJ335's accounts.

In some example implementations, JJ335 may be given a choice (e.g., using a UI widget, not shown) to select one or more of his or her online accounts to suspend activity. For example, JJ335 may suspend the activity of one account at a time, a group of two or more accounts at a time, or all accounts at a time.

As an example, JJ335 suspends the activity of his or her email account by selecting (e.g., touch-activating, pushing or clicking) on the “Emergency/Suspend Account” button 235. The service provider for JJ335's email account may be, for example, service provider 280. Service provider 280 receives the input generated by the activation of the “Emergency/Suspend Account” button 235 via network 245. The input is interpreted by the service provider 280 as a request for suspending or stopping all activity of JJ335's accounts.

For example, JJ335 may have an instant messaging or video chat account and may use it to communicate, arrow 255, with mobile user 250 (e.g., user JJ335's spouse). JJ335's communication or account activity provides his or her spouse with access to JJ335's status, current condition, and/or other information associated with JJ335. JJ335 may use his or her Email account to communicate, by arrow 265, with user 260 (e.g., JJ335's colleague). The email communication or email account activity provides his or her colleague with access to, for example, JJ335's sales reports, product design input, and/or other information associated with JJ335. JJ335 may participate in an online community or social group on social network 270, arrow 275, using her social network account.

The activity of JJ335's social network account allows his or her friends, family members, and/or circles of social users to keep in touch with JJ335 (e.g., provides JJ335's circles of users with access to information associated with JJ335, such as his or her latest vacation photos).

In response to the request, service provider 280 suspends JJ335's account activity (e.g., of one account, some accounts, or all accounts). When JJ335's account activity is stopped, frozen, or suspended, information associated with him or her is no longer communicated to other users through the suspended accounts. In some example implementations, only the outbound account activity (e.g., from or initiated by JJ335) is suspended. In other example implementations, both outbound and inbound activity (e.g., JJ335 is the recipient or target) are suspended.

Note that the “other users” are any users or types of users (e.g., end users) other than the users (internal users) working on behalf of the service providers that provide the online accounts or services associated with the online-account activity. These internal users may be employees, contractors, or other users authorized by the service provider on its behalf (e.g., to help JJ335 to resolve any issues associated with JJ335's accounts).

Stopping, freezing, suspending, or otherwise interrupting the activity of an account may be implemented using one or more settings, switches, variables, or flags. For example, a flag may be used to indicate whether the activity of one or more accounts is suspended. A value may be chosen to indicate that the outbound activity, inbound activity, or both are suspended (e.g., “01”, “10”, or “11”, respectively).

Another implementation may be using two or more flags, such as using one flag to indicate the stage of the outbound activity of one or more accounts and another flag to indicate the stage of the inbound activity of one or more accounts. In some example implementations, flags are used based on each account or each group of accounts. For example, each account or group of accounts may have one or more flags assigned to it at all times, or at the time a user (e.g., JJ335) selects the accounts to suspend their activity.

A flag may hold values that indicate different stages of activity. For example, one value may be used to indicate that the activity is unsuspended (e.g., normal activity or account operation). Another value may be used to indicate that the activity (e.g., inbound, outbound, or both) is suspended. If there are separate flags for inbound, outbound, and other category of activity, the suspended stage is an indication for that category of activity (e.g., inbound or outbound).

In some example implementations, there may be one or more intermediate stages, gradual stages, or other stages, in which some activity is suspended and some activity is not suspended. In each of these stages, there may be a different degree of suspension and/or a different type/category of activity being suspended. For example, a safe mode stage may allow activity to and from specific users (e.g., whitelist of users). Another intermediate stage may involve communication from and to close friends or colleague. Yet, another stage may be based on one or more types of information or communication (e.g., allowing only inbound emails with a prescribed email address on the “To:” line).

In some example implementations, one or more snapshots that represent the user's account activity stages prior to suspension may be taken. The snapshots may be used in resuming account activity from the suspension.

User JJ335 may be provided assistance, such as a user interface, that guides him or her through the resumption process to resume account activity. The assistance may come in any form, including the form of online interactive guidance, a wizard, an interactive interview, an emergency card (e.g., check list), or a combination thereof.

In some example implementations, the resumption of activity may be gradual or quick, piecemeal or all at once. For example, JJ335 may be guided to resume the activity to and from one or more users at a time, one or more groups, circles, or social graphs at a time. In some example implementations, account activity may be resume one account at a time, one type of activity (e.g., inbound or outbound) at a time, one stage at a time (e.g., from suspension to one or more stages of partial suspension/resumption, then to full resumption), or by other fashion.

In other example implementations, the resumption may be performed in response to a single command or single action by the user (e.g., clicking on a “Resume Activity” button, not shown).

To resume account activity, one or more snapshots of pre-suspension stages, saved before the suspension, may be used. For example, after JJ335 has determined that one or more of his or her accounts are ready to resume activity, one option may be provided (not shown) is resume “activity level as before suspension”. This option may be implemented by setting one or more flags to values saved by the snapshots of the pre-suspension stages.

In some example implementations, when JJ335 suspends his or her accounts (e.g., activates the “Emergency/Suspend Account” button), one or more alerts may be generated (e.g., by a servicer provider of the accounts) and sent to one or more internal users (e.g., representatives of the service provider). The service provider provides services associated with at least one of JJ335's accounts.

In some example implementations, when JJ335 suspends his or her accounts, information about the suspension and/or the suspended account may be communicated to JJ335 using a channel of communication not associated with any of the suspended accounts. For example, an email message about the suspension may be sent to user JJ335's email address or a mobile phone associated with an account that is not being suspended (e.g., an email account associated with another service provider).

In some example implementations, when JJ335 suspends an account, the service provider associated with that account may maintain a status of “unknown,” “unavailable,” “inactive”, “suspended,” “error”, etc. That status may be communicated to another user who inquires about JJ335, or attempts to communicate with JJ335.

In some example implementations, a mechanism, user interface, or wizard (not shown) may be provided to guide a user to unfreeze or resume one or more suspended activities. For example, the user interface may be designed to receive input from a user and provide information and one or more controls based on the user input. The one or more controls allow the user to resume one or more portions of the user's online-account activity. For example, a control or widget may be used to change one or more flags from a suspended stage to an intermediate stage or to an unsuspended stage. In some example implementations, the user interface may provide information and/or explanations associated with the suspended stage, the intermediate stage, and/or the unsuspended stage.

### Example Processes

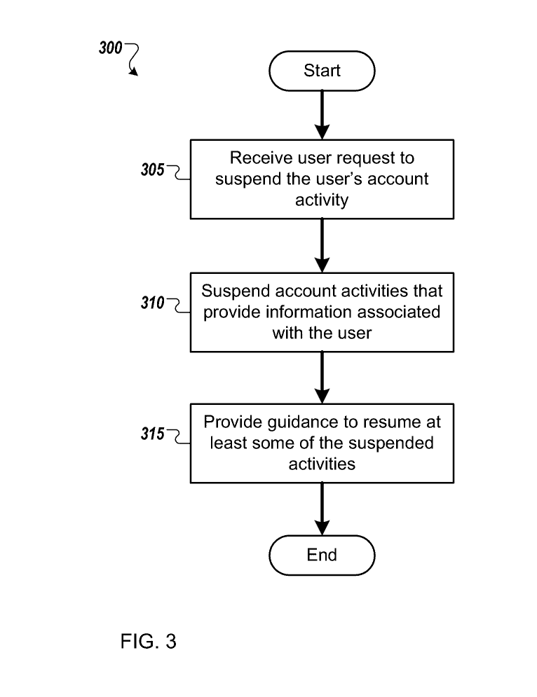

FIG. 3 shows an example process suitable for implementing some example implementations. A user (e.g., user JJ335) may initiate suspension of one or more of his or her online-account activity (e.g., pressing the “Emergency/Suspend Account” button 235, FIG. 2). At 305, a service provider (e.g., service provider 280) receives a request from the user to suspend the online-account activity. The online-account activity provides or allows one or more other users access to information associated with or about JJ335. In response to the request, at 310, service provider 280 suspends the online-account activity. Account activity normally provides information or access of information about JJ335. The suspension of the activity discontinues or stops other users from getting, receiving, or accessing the information associated with JJ335. At 315, service provider 280 provides online interactive guidance to JJ335, so as to assist him or her to resume at least a portion of the suspended online-account activity (e.g., revoking some or all of the suspension).

In some examples, process 300 may be implemented with different, fewer, or more steps. Process 300 may be implemented as computer executable instructions, which can be stored on a medium, loaded onto one or processors of one or more computing devices, and executed as a computer-implemented method.

### Example Computing Devices And Environments

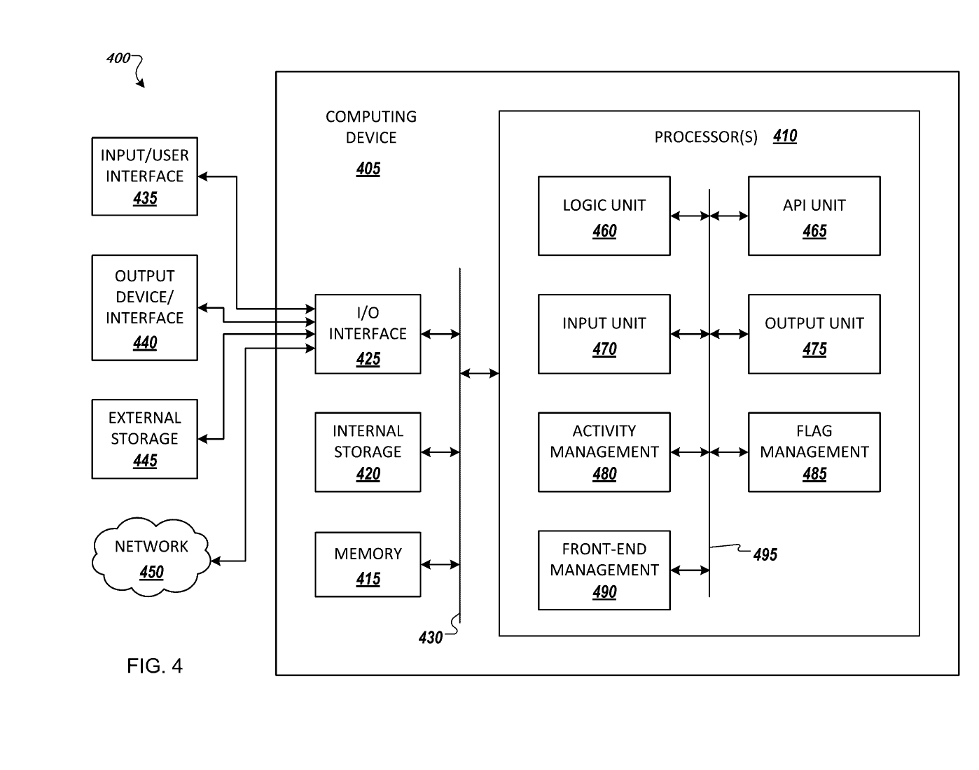

FIG. 4 shows an example computing environment with an example computing device suitable for implementing at least one example implementation. Computing device 405 in computing environment 400 can include one or more processing units, cores, or processors 410, memory 415 (e.g., RAM, ROM, and/or the like), internal storage 420 (e.g., magnetic, optical, solid state storage, and/or organic), and I/O interface 425, all of which can be coupled on a communication mechanism or bus 430 for communicating information.

Computing device 405 can be communicatively coupled to input/user interface 435 and output device/interface 440. Either one or both of input/user interface 435 and output device/interface 440 can be wired or wireless interface and can be detachable. Input/user interface 435 may include any device, component, sensor, or interface, physical or virtual, that can be used to provide input (e.g., keyboard, a pointing/cursor control, microphone, camera, braille, motion sensor, optical reader, and/or the like). Output device/interface 440 may include a display, monitor, printer, speaker, braille, or the like. In some example implementations, input/user interface 435 and output device/interface 440 can be embedded with or physically coupled to computing device 405 (e.g., a mobile computing device with buttons or touch-screen input/user interface and an output or printing display, or a television).

Computing device 405 can be communicatively coupled to external storage 445 and network 450 for communicating with any number of networked components, devices, and systems, including one or more computing devices of same or different configuration. Computing device 405 or any connected computing device can be functioning as, providing services of, or referred to as a server, client, thin server, general machine, special-purpose machine, or another label.

I/O interface 425 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 400. Network 450 can be any network or combination of networks (e.g., the Internet, local area network, wide area network, a telephonic network, a cellular network, satellite network, and the like).

Computing device 405 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 405 can be used to implement techniques, methods, applications, processes, or computer-executable instructions to implement at least one implementation (e.g., a described implementation). Computer-executable instructions can be retrieved from transitory media, and stored on and retrieved from non-transitory media. The executable instructions can be originated from one or more of any programming, scripting, and machine languages (e.g., C, C++, C#, Java, Visual Basic, Python, Perl, JavaScript, and others).

Processor(s) 410 can execute under any operating system (OS) (not shown), in a native or virtual environment. To implement a described implementation, one or more applications can be deployed that include logic unit 460, application programming interface (API) unit 465, input unit 470, output unit 475, user data management unit 480, setting management unit 485, front-end management unit 490, and inter-unit communication mechanism 495 for the different units to communicate with each other, with the OS, and with other applications (not shown). For example, activity management unit 480, flag management unit 485, front-end management unit 490 may implement one or more processes shown in FIG. 3. The described units and elements can be varied in design, function, configuration, or implementation and are not limited to the descriptions provided.

In some example implementations, when information or an execution instruction is received by API unit 465, it may be communicated to one or more other units (e.g., logic unit 460, input unit 470, output unit 475, activity management unit 480, flag management unit 485, front-end management unit 490). For example, after input unit 470 has detected a user suspension request (e.g., detecting the button 235, FIG. 2, being activated), input unit 470 may use API unit 465 to communicate the user indication to activity management unit 480. Activity management unit 480 may, via API unit 445, communicate the user request to the flag management unit 485 to modify one or more user flags to suspend the activity of one or more accounts. Using API unit 465, activity management unit 480 may interact with front-end management unit 490. Front-end management unit 490 may then use output unit 475 to provide interactive guidance to assist the user to resume at least a portion of the online-account activity.

In some examples, logic unit 460 may be configured to control the information flow among the units and direct the services provided by API unit 465, input unit 470, output unit 475, activity management unit 480, flag management unit 485, front-end management unit 490 in order to implement an implementation described above. For example, the flow of one or more processes or implementations may be controlled by logic unit 460 alone or in conjunction with API unit 465.

The example implementations may have various benefits and/or advantages. For example, but not by way of limitation, a user may save time and/or data by being able to appropriately react to online threats and emergencies. Further, a user may feel less stress or tension in an emergency situation, because they can rely on the example implementations. Additionally, a user may feel more willing to experiment with additional online services, if they feel that they could undo potential activity that may occur on the account as a result of the experimentation. Thus, a user may be more likely to have an unrestrained or less restrained user experience.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Although a few example implementations have been shown and described, these example implementations are provided to convey the subject matter described herein to people who are familiar with this field. It should be understood that the subject matter described herein may be embodied in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

1. A computer-implemented method for user-initiated suspension of online-account activity associated with a first user, and assisting the first user to revoke the user-initiated suspension of the online-account activity, the method comprising:
one or more computing devices receiving a request from the first user to suspend the online-account activity, wherein the online-account activity comprises providing at least one other user with access to information associated with the first user;
in response to the request, the one or more computing devices suspending the online-account activity so that the at least one other user cannot access the information associated with the first user, and saving a value indicative of account activity in a pre-suspension stage;
the one or more computing devices providing online interactive guidance to the first user, so as to assist the first user to resume at least a portion of the online-account activity; and
the one or more computing devices resuming the at least the portion of the online-account activity to the account activity provided in the value indicative of account activity in a pre-suspension stage.

2. The method of claim 1, wherein the request from the first user is generated from a single action performed by the first user.

3. The method of claim 1, wherein the suspending the online-account activity comprises setting, without further action by the first user, at least one flag to indicate that the online-account activity is in a suspended stage, the at least one flag is implemented to indicate a plurality of stages including the suspended stage and an unsuspended stage of the online-account activity.

4. The method of claim 3, further comprising, before setting the at least one flag, saving the stage indicated by the at least one flag.

5. The method of claim 1, wherein the suspending the online-account activity comprises setting at least one flag associated with a state of inbound activity, and a state of outbound activity, wherein the one or more computing devices provides the online interactive guidance based on a value of the at least one flag.

6. The method of claim 1, wherein the at least one other user is not a user working on behalf of a service provider that provides services associated with the online-account activity.

7. The method of claim 1, further comprising sending an alert to a representative of a service provider that provides services associated with the online-account activity.

8. The method of claim 1, further comprising providing information to the first user using a channel of communication not associated with the online-account activity.

9. The method of claim 1, wherein the providing the online interactive guidance comprises providing a user interface designed to take input from the first user and provide information and at least one control based on the input, the at least one control allows the first user to resume the at least a portion of the online-account activity.

10. The method of claim 4, wherein the providing the online interactive guidance comprises providing a user interface comprising:
at least one widget designed to change the suspended stage of the at least one flag to an intermediate stage or the unsuspended stage; and
information associated with and providing explanation on each of the suspended stage, the intermediate stage, and the unsuspended stage.

11. A non-transitory computer readable medium having stored therein computer executable instructions for user-initiated suspension of online-account activity associated with a first user, and assisting the first user to revoke the user-initiated suspension of the online-account activity, the instructions comprising:
receiving a request from the first user to suspend the online-account activity, wherein the online-account activity comprises providing at least one other user with access to information associated with the first user;
in response to the request, suspending the online-account activity so that the at least one other user cannot access the information associated with the first user, and saving a value indicative of account activity in a pre-suspension stage;
providing online interactive guidance to the first user, so as to assist the first user to resume at least a portion of the online-account activity; and
resuming the at least the portion of the online-account activity to the account activity provided in the value indicative of account activity in a pre-suspension stage.

12. The non-transitory computer readable medium of claim 11, wherein the request from the first user is generated from a single action performed by the first user.

13. The non-transitory computer readable medium of claim 11, wherein the suspending the online-account activity comprises setting, without further action by the first user, at least one flag to indicate that the online-account activity is in a suspended stage, the at least one flag is implemented to indicate a plurality of stages including the suspended stage and an unsuspended stage of the online-account activity wherein the online interactive guidance is provided based on a value of the at least one flag.

14. The non-transitory computer readable medium of claim 11, wherein the at least one other user is not a user working on behalf of a service provider that provides services associated with the online-account activity.

15. The non-transitory computer readable medium of claim 11, wherein the providing the online interactive guidance comprises providing a user interface designed to take input from the first user and provide information and at least one control based on the input, the at least one control allows the first user to resume the at least a portion of the online-account activity.

16. At least one device comprising a storage and at least one processor configured for user-initiated suspension of online-account activity associated with a first user, and assisting the first user to revoke the user-initiated suspension of the online-account activity, the at least one processor:
receiving a request from the first user to suspend the online-account activity, wherein the online-account activity comprises providing at least one other user with access to information associated with the first user;
in response to the request, suspending the online-account activity so that the at least one other user cannot access the information associated with the first user, and saving a value indicative of account activity in a pre-suspension stage;
providing online interactive guidance to the first user, so as to assist the first user to resume at least a portion of the online-account activity; and
resuming the at least the portion of the online-account activity to the account activity provided in the value indicative of account activity in a pre-suspension stage.

17. The at least one device of claim 16, wherein the request from the first user is generated from a single action performed by the first user.

18. The at least one device of claim 16, wherein the suspending the online-account activity comprises setting, without further action by the first user, at least one flag to indicate that the online-account activity is in a suspended stage, the at least one flag is implemented to indicate a plurality of stages including the suspended stage and an unsuspended stage of the online-account activity wherein the at least one processor provides the online interactive guidance based on a value of the at least one flag.

19. The at least one device of claim 16, wherein the at least one other user is not a user working on behalf of a service provider that provides services associated with the online-account activity.

20. The at least one device of claim 16, wherein the providing the online interactive guidance comprises providing a user interface designed to take input from the first user and provide information and at least one control based on the input, the at least one control allows the first user to resume the at least a portion of the online-account activity.
